(19) United States
(12) Patent Application Publication
(10) Pub. No.: US 2024/0230456 A1
(43) Pub. Date: Jul. 11, 2024

(54) HYDROGEN LEAK DETECTION DEVICE FOR HYDROGEN PIPELINE, CONTROLLER, AND HYDROGEN LEAK DETECTION METHOD

(71) Applicant: Brother Kogyo Kabushiki Kaisha, Nagoya (JP)

(72) Inventors: Hiroshi Kuno, Ogaki (JP); Mitsuru Ohta, Kani (JP)

(21) Appl. No.: 18/612,040

(22) Filed: Mar. 21, 2024

Related U.S. Application Data
(63) Continuation of application No. PCT/JP2022/013019, filed on Mar. 22, 2022.

(30) Foreign Application Priority Data
Sep. 21, 2021 (JP) 2021-152761

(51) Int. Cl. G01M 3/28; F17D 5/02

(52) U.S. Cl. CPC G01M 3/2807; F17D 5/02

(57) ABSTRACT

A hydrogen leakage detection device includes a controller configured to receive a first hydrogen consumption amount from each of the hydrogen consumption devices via a communication device; control a pressure regulator such that a first flow amount of hydrogen gas flowing in a hydrogen pipeline corresponds to an amount equal to a first sum of the first hydrogen consumption amounts; in response to a check instruction outputted based on establishment of a particular condition or at a particular timing, receive a second hydrogen consumption amount from each of the hydrogen consumption devices and a second flow amount of the hydrogen gas; determine whether the second flow amount is greater than a second sum of the second hydrogen consumption amounts; and in response to a determination that the second flow amount is greater than the second sum of the second hydrogen consumption amounts, determine that a hydrogen gas leak has occurred.

### REFERENCE TO RELATED APPLICATIONS

This is a continuation application of International Application No. PCT/JP2022/013019 filed on Mar. 22, 2022, which claims priority from Japanese Patent Application No. 2021-152761 filed on Sep. 21, 2021. The entire contents of the aforementioned applications are incorporated herein by reference.

### BACKGROUND ART

Attempts have been made to supply hydrogen gas stored in a gas tank to hydrogen consumption devices, such as fuel cells using hydrogen gas and oxygen gas, installed at respective remote locations via a pipeline.

### SUMMARY

A pipeline having a double-pipe structure may be used as a measure to prevent a hydrogen leak from the pipeline. In a case where such a pipeline is installed underground, an exhaust device may need to be installed in case of hydrogen leak to prevent leaking hydrogen from staying in the pipeline, which may increase in cost.

A suggestion may be provided that a pipeline for conveying hydrogen gas be installed at an altitude as high as possible from the ground surface for safety. In an aerial pipeline, even if hydrogen gas leaks from the pipeline, the hydrogen gas diffuses into the air and does not tend to stay at a location where the hydrogen gas leaks and its surroundings.

In order to supply sufficient hydrogen to each of the hydrogen consumption devices so that the hydrogen consumption devices can produce their maximum output, high-pressure hydrogen gas may need to be supplied to the pipeline. Pipes used for the pipeline to which high-pressure hydrogen gas can be supplied may have a relatively thick wall and a relatively large diameter for enhancing its strength, thereby having a relatively heavy weight, which may cause difficulty in aerial installation of such a heavy pipeline. On the contrary, in a case where a pipeline using pipes having a relatively light weight is aerially installed, the pipeline may be damaged or broken due to its low strength, thereby causing a hydrogen gas leak from the pipeline. If a hydrogen gas leak occurs at the aerial pipeline, the leaking hydrogen gas may diffuse into the air, thereby causing difficulty in detection of a leak even if a smell is added to the hydrogen gas.

Aspects of the disclosure provide a hydrogen leak detection device for a hydrogen pipeline using pipes having a relatively light weight, a controller of the hydrogen leak detection device, and a hydrogen leak detection method in the hydrogen pipeline, wherein the hydrogen leak detection device may secure safety and readily detects a hydrogen gas leak.

In one aspect of the disclosure, a hydrogen leakage detection device for detecting a hydrogen gas leak at an aerial hydrogen pipeline for supplying hydrogen gas from a gas tank to a plurality of hydrogen consumption devices may include a pressure regulator, a controller, a communication device, and a flow sensor. The hydrogen pipeline may include a hydrogen channel that extends from the gas tank and branches off at branching positions to the plurality of hydrogen consumption devices. The pressure regulator may be disposed at the hydrogen pipeline and adjacent to the gas tank. The pressure regulator may be configured to adjust a pressure of the hydrogen gas discharged from the gas tank. The controller may be configured to control the pressure regulator. The communication device may be connected to the controller and each of the plurality of hydrogen consumption devices. The communication device may enable the controller and the plurality of hydrogen consumption devices to communicate with each other. The flow sensor may be disposed upstream from a particular branching position at the hydrogen channel. The particular branching position may be closest to the gas tank among the branching positions. The flow sensor may be configured to measure a flow amount of the hydrogen gas flowing in the hydrogen pipeline and transmit the measured flow amount to the controller. The controller is configured to: receive a first hydrogen consumption amount from each of the hydrogen consumption devices via the communication device; control the pressure regulator such that a first flow amount of the hydrogen gas flowing in the hydrogen pipeline corresponds to an amount equal to a first sum of the first hydrogen consumption amounts; in response to a check instruction outputted based on establishment of a particular condition or at a particular timing, receive a second hydrogen consumption amount from each of the hydrogen consumption devices and a second flow amount measured by the flow sensor; determine whether the second flow amount is greater than a second sum of the second hydrogen consumption amounts; and in response to a determination that the second flow amount is greater than the second sum of the second hydrogen consumption amounts, determine that a hydrogen gas leak has occurred.

Hydrogen gas has a specific gravity less than that of the air. Even if the hydrogen gas leaks, the hydrogen gas diffuses into the air at once from the aerial hydrogen pipeline, thereby not staying at the hydrogen supply pipeline and its surroundings. The hydrogen leak detection device may detect a hydrogen gas leak in the hydrogen pipeline readily by comparing the amount of hydrogen gas flowing in the gas tank that is a supplier of the hydrogen gas and the sum of hydrogen consumption amounts of the hydrogen consumption devices that are destinations of the hydrogen gas.

In another aspect of the disclosure, a controller of a hydrogen leak detection device for detecting a hydrogen gas leak at an aerial hydrogen pipeline for supplying hydrogen gas from a gas tank to a plurality of hydrogen consumption devices may be configured to control a pressure regulator and a communication device. The hydrogen pipeline may include a hydrogen channel that extends from the gas tank and branches off at branching positions to the plurality of hydrogen consumption devices. The hydrogen leak detection device may include the pressure regulator, the communication device, and a flow sensor. The pressure regulator may be disposed at the hydrogen pipeline and adjacent to the gas tank. The pressure regulator may be configured to adjust a pressure of the hydrogen gas discharged from the gas tank. The communication device may be connected to each of the plurality of hydrogen consumption devices. The communication device may enable the controller to communicate with each of the plurality of hydrogen consumption devices. The flow sensor may be disposed upstream from a particular branching position at the hydrogen channel. The particular branching position may be closest to the gas tank among the branching positions, The flow sensor may be configured to measure a flow amount of the hydrogen gas flowing in the hydrogen pipeline and transmit the measured flow amount to the controller. The controller may be configured to: receive a first hydrogen consumption amount from each of the hydrogen consumption devices via the communication device; control the pressure regulator such that a first flow amount of the hydrogen gas flowing in the hydrogen pipeline corresponds to an amount equal to a first sum of the first hydrogen consumption amounts; in response to a check instruction outputted based on establishment of a particular condition or at a particular timing, receive a second hydrogen consumption amount from each of the hydrogen consumption devices and a second flow amount measured by the flow sensor; determine whether the second flow amount is greater than a second sum of the second hydrogen consumption amounts; and in response to a determination that the second flow amount is greater than the second sum of the second hydrogen consumption amounts, determine that a hydrogen gas leak has occurred. According to the other aspect, the same effects as in the one aspect are achieved.

In a still another aspect of the disclosure, a method of detecting a hydrogen leak at a hydrogen pipeline connecting a gas tank and a plurality of hydrogen consumption devices, the hydrogen pipeline including a pressure regulator configured to adjust a pressure of hydrogen gas discharged from the gas tank and a flow sensor configured to measure a flow amount of the hydrogen gas flowing in the hydrogen pipeline, the pressure regulator and the flow sensor being disposed adjacent to the gas tank, may include: controlling the pressure regulator during hydrogen gas supply such that a first flow amount of the hydrogen gas flowing in the hydrogen pipeline corresponds to an amount equal to a first sum of first hydrogen consumption amounts; in response to a check instruction outputted based on establishment of a particular condition, comparing the first flow amount measured by the flow sensor and the first sum; based on a result of the comparison, determining whether the first flow amount is greater than the first sum; in response to a determination that the first flow amount is greater than the first sum, determining that a hydrogen gas leak has occurred at the hydrogen pipeline; in response to a determination that a hydrogen gas leak has occurred at the hydrogen pipeline, stopping controlling the pressure regulator such that the first flow amount of the hydrogen gas flowing in the hydrogen pipeline corresponds to the amount equal to the first sum of the first hydrogen consumption amounts, and controlling the pressure regulator to raise the pressure of the hydrogen gas to a particular pressure; subsequent to raising the pressure of the hydrogen gas to the particular pressure, receiving a second hydrogen consumption amount from each of the hydrogen consumption devices and a second flow amount measured by the flow sensor; calculating a difference between the second flow amount and a second sum of the second hydrogen consumption amounts; determining whether the difference is greater than the first difference; and in response to a determination that the second difference is greater than the first difference, determining that the hydrogen gas leak has occurred.

Hydrogen gas has a specific gravity less than that of the air. Even if the hydrogen gas leaks, the hydrogen gas diffuses into the air at once from the aerial hydrogen pipeline, thereby not staying at the hydrogen supply pipeline and its surroundings. The hydrogen leak detection device may detect a hydrogen gas leak in the hydrogen pipeline readily by comparing the first amount of hydrogen gas flowing in the gas tank that is a supplier of the hydrogen gas and the first sum of the first hydrogen consumption amounts of the hydrogen consumption devices that are destinations of the hydrogen gas.

In a case where the amount of the hydrogen gas flowing in the hydrogen pipeline is lower than the sum after comparison, reliability of the leak determination may be low due to measurement errors in the hydrogen consumption amounts of the hydrogen consumption devices and the flow amount of the hydrogen gas measured by the flow sensor. In this case, the flow sensor may raise the pressure of the hydrogen gas to a particular pressure. Since the hydrogen gas has high fluidity, the flow amount of the hydrogen gas increases instantly in response to the pressure raising. If the flow amount has increased as compared with the last flow amount in response to the pressure raising, the determination that a hydrogen leak has occurred has reliability. Since the flow amount of the hydrogen gas instantly changes, it may be readily determined whether a leak has occurred.

### BRIEF DESCRIPTION OF THE DRAWINGS

FIG. 1 illustrates an installation example of a hydrogen pipeline and a hydrogen leak detection device.

FIG. 2 is a flowchart of a consumption amount transmission process executed by a hydrogen consumption device.

FIG. 3A is a flowchart of a leak detection process executed by the hydrogen leak detection device.

FIG. 3B is a flowchart of a continuation of the leak detection process.

FIG. 4A is a flowchart of a continuation of the leak detection process.

FIG. 4B is a flowchart of a continuation of the leak detection process.

FIG. 5 is a flowchart of a leak check instruction process executed by the hydrogen leak detection device.

### DESCRIPTION

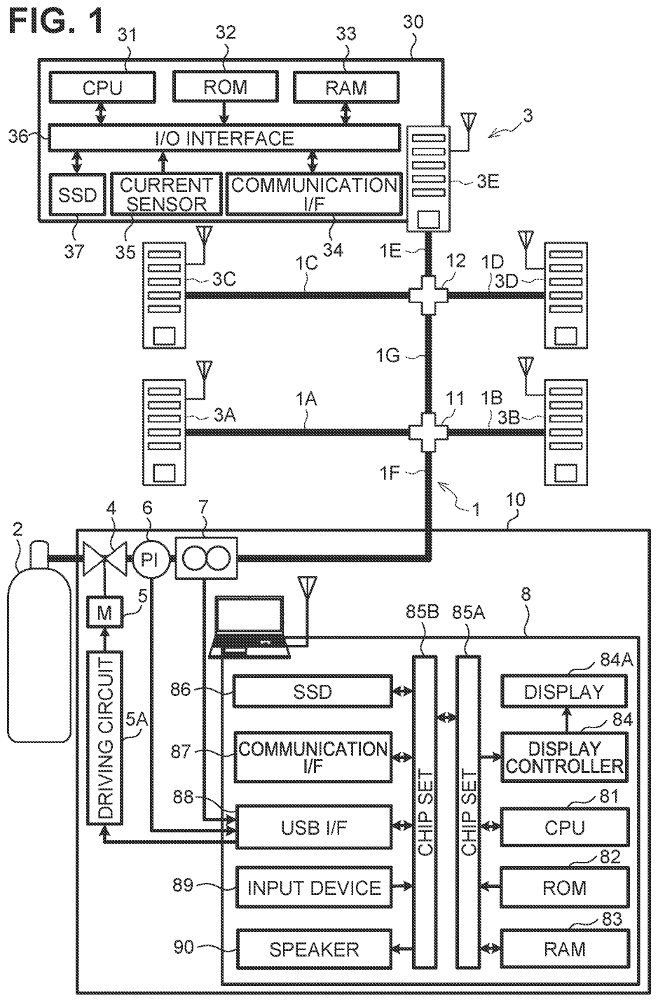

Referring to FIG. 1, a description will be provided on an installation example of a hydrogen pipeline 1 and a hydrogen leak detection device 10 according to an illustrative embodiment of the disclosure. The hydrogen pipeline 1 is a system of pipes for conveying hydrogen gas from a gas tank 2 containing the hydrogen gas to hydrogen consumption devices 3 that consume the supplied hydrogen gas. The gas tank 2 is a container for storing compressed hydrogen gas or liquefied hydrogen, and has an appropriate size for demand. Examples of the hydrogen consumption devices 3 include a dispenser that supplies hydrogen gas to a fuel cell that uses the hydrogen gas for electric power generation and a dispenser that supplies hydrogen gas to a fuel cell vehicle. In the illustrative embodiment, a plurality of, for example, five hydrogen consumption devices 3 each equipped with a fuel cell are installed. In the description below, when the hydrogen consumption devices 3 are distinguished therebetween, specific letters A to E are appended to their reference numerals, and otherwise, the specific letters are omitted when the hydrogen consumption devices 3 are collectively referred to.

Each of the fuel cells generates electric power by a chemical reaction between the hydrogen gas supplied from the gas tank 2 through the hydrogen pipeline 1 and oxygen. The electric power generated by the electric power generation is supplied to a demand site. Each of the hydrogen consumption devices 3 includes a controller 30 for monitoring an amount of hydrogen gas that has been supplied to the fuel cell to maintain a stable supply of the hydrogen gas. The controller 30 includes a CPU 31, a ROM 32, a RAM 33, a communication interface (I/F) 34, a current sensor 35, and a solid-state drive (SSD) 37, which are electrically connected to each other via an input/output (I/O) interface 36. The CPU 31 controls a monitoring process executed by the controller 30, in which the amount of hydrogen gas that has been supplied to the fuel cell is monitored. The ROM 32 stores a program for monitoring the amount of hydrogen gas that has been supplied. The RAM 33 stores various temporary data. The communication I/F 34 enables the hydrogen consumption device 3 to perform wired or wireless data transmission with a PC 8 that controls the hydrogen leak detection device 10. The current sensor 35 detects and measures current passing therethrough when electric power generated by electric power generation by the fuel cell is supplied to a demand site. The SSD 37 is a non-volatile storage device, and stores, for example, a program for the controller 30 to execute a consumption amount transmission process and other programs, and data.

The hydrogen pipeline 1 is an aerial pipeline and includes supply pipes constituting hydrogen channels for conveying hydrogen gas. Specifically, the hydrogen pipeline 1 is installed such that, for example, the supply pipes are routed along suspension wires running between concrete poles located at certain intervals using a spiral suspension member such as a lashing rod or a cable hanger. In the hydrogen pipeline 1, stainless steel accordion supply pipes having flexibility in bending may be used. The supply pipes are covered with resin, for example, ethylene propylene diene rubber (EPDM), for weather resistance. Hydrogen is lighter than air. Thus, even if hydrogen gas leaks from the hydrogen pipeline 1 due to damage or braking of the hydrogen pipeline 1, the hydrogen gas diffuses into the air at once at the leak point of the hydrogen pipeline 1 aerially installed at the location above a living area. Therefore, ventilation equipment might not necessarily be provided to the hydrogen pipeline 1, and addition of an odorant to the hydrogen gas might also not necessarily be required.

Hydrogen gas is compressed to, for example, 100 MPa and stored in the gas tank 2. When the hydrogen gas is supplied to the hydrogen pipeline 1 from the gas tank 2, the hydrogen gas is decompressed to below 1 MPa for safety. A hydrogen molecule is the smallest molecule in size. Thus, hydrogen gas may be conveyed at a high speed in the hydrogen gas supply pipes. Accordingly, even when an internal pressure of the hydrogen gas supply pipes is at a relatively low pressure of, for example, 0.2 MPa and the hydrogen gas supply pipes have a diameter smaller than that of a typical hydrogen gas supply pipe, a sufficient amount of hydrogen gas for each of the hydrogen consumption devices 3 may be conveyed through the supply pipes. Consequently, in the hydrogen pipeline 1, the relatively light flexible supply pipes having a relatively small diameter are used. Such supply pipes have flexibility and a strength sufficient to reduce or prevent a leak of hydrogen gas. This feature may be suitable for aerial installation of the hydrogen pipeline 1.

The hydrogen pipeline 1 is expandable by connecting the supply pipes each having a length of, for example, 30 m to each other using joints. The hydrogen pipeline 1 includes branching parts 11 and 12 and a plurality of pipeline segments 1A, 1B, 1C, 1D, 1E, 1F, and 1G to be connected to each of the hydrogen consumption devices 3. The branching parts 11 and 12 may be joints, and join the pipeline segments 1A to 1G to each other by welding. In the illustrative embodiment, the gas tank 2 is located upstream from the branching part 11 in a direction in which the hydrogen gas flows from the gas tank 2 toward each of the hydrogen consumption devices 3 (hereinafter, referred to as the “gas flow direction”) and is connected to the hydrogen pipeline 1 via the pipeline segment 1F. The hydrogen consumption devices 3A and 3B are located downstream from the branching part 11 in the gas flow direction and are connected to the hydrogen pipeline 1 via the pipeline segments 1A and 1B, respectively. The branching part 11 and the branching part 12 are connected to each other via the pipeline segment 1G. The hydrogen consumption devices 3C, 3D, and 3E are located downstream from the branching part 12 in the gas flow direction and are connected to the hydrogen pipeline 1 via the pipeline segments 1C, 1D, and 1E, respectively.

The hydrogen leak detection device 10 is connected to the pipeline segment 1F to which the gas tank 2 is connected. The hydrogen leak detection device 10 includes a pressure reducing valve 4, a motor 5, a drive circuit 5A, a pressure indicator 6, a flow sensor 7, and the PC 8. The pipeline segment 1F has a first end and a second end farther from the gas tank 2 than the first end is from. The pressure reducing valve 4, the pressure indicator 6, and the flow sensor 7 are disposed closer to the first end of the pipeline segment 1F than to the second end of the pipeline segment 1F. The pressure reducing valve 4 adjusts the pressure level of the high-pressure hydrogen gas discharged from the gas tank 2 to a level that is below 1 MPa and is a minimum level that the hydrogen pipeline 1 can supply an amount of hydrogen gas corresponding to an amount of hydrogen gas that the hydrogen consumption devices 3 consume and allows the hydrogen gas whose pressure level has been adjusted to be supplied to the hydrogen pipeline 1. The motor 5 may be, for example, a stepping motor, and is connected to an on/off valve of the pressure reducing valve 4. The drive circuit 5A is connected to the motor 5 and controls driving of the motor 5 in accordance with an instruction from the PC 8. The motor 5 drives the on/off valve of the pressure reducing valve 4 to adjust the pressure level of the hydrogen gas that is discharged from the gas tank 2 and is to be supplied to the hydrogen pipeline 1.

The pressure indicator 6 is located downstream from the pressure reducing valve 4 in the gas flow direction and is connected to the pipeline segment 1F. The pressure indicator 6 measures the pressure of the hydrogen gas that has been decompressed by the pressure reducing valve 4. The pressure indicator 6 is connected to the PC 8 and outputs the measured pressure value to the PC 8. The flow sensor 7 is located downstream from the pressure indicator 6 in the gas flow direction and is connected to the pipeline segment 1F. The flow sensor 7 measures an amount of the hydrogen gas flowing through the pipeline segment 1F. The flow sensor 7 is connected to the PC 8 and outputs the measured amount to the PC 8.

The PC 8 may be a general-purpose computer. The PC 8 includes a CPU 81 that controls operations of the PC 8. The CPU 81 is connected to a chipset 85A, and is electrically connected to a ROM 82, a RAM 83, and a display controller 84 via the chipset 85A. The display controller 84 is connected to a display 84A. The chipset 85A is connected to a chipset 85B. The CPU 81 is electrically connected to an SSD 86, a communication I/F 87, a USB I/F 88, an input device 89, and a speaker 90 via the chipset 85B.

The chipset 85A is a set of circuits that manages data transmission and reception between the CPU 81, the ROM 82, the RAM 83, and the display controller 84. The ROM 82 stores, for example, a boot program and a basic input/output system (BIOS). The RAM 83 stores various temporary data. The display controller 84 controls display of an image on the display 84A. The chipset 85B is a set of circuits that manages data transmission and reception between the CPU 81 and the SSD 86, the communication I/F 87, the USB I/F 88, and the input device 89. The SSD 86 may be a nonvolatile storage device that stores, for example, an operation system (OS), software that causes the PC 8 to function as a controller of the hydrogen leak detection device 10, various applications, and data.

The communication I/F 87 enables the PC 8 to perform wired or wireless data transmission with each of the hydrogen consumption devices 3. The USB I/F 88 enables the PC 8 to perform communication in accordance with a USB standard. The CPU 81 controls driving of the motor 5 that opens and closes the pressure reducing valve 4, and receives the measurement results of the pressure indicator 6 and the flow sensor 7, via the USB I/F 88. Examples of the input device 89 include a keyboard and a mouse that are a device for inputting an operation performed on the PC 8. The speaker 90 outputs sound based on sound data.

Next, a description will be provided on an outline of a method in which the hydrogen leak detection device 10 detects the presence or absence of a hydrogen gas leak. The hydrogen leak detection device 10 controls the motor 5 to control the pressure reducing valve 4, thereby adjusting the pressure of the high-pressure hydrogen gas discharged from the gas tank 2 to a level that is below 1 MPa and is a minimum level that the hydrogen pipeline 1 can supply the amount of hydrogen gas corresponding to the amount of hydrogen gas that the hydrogen consumption devices 3 consume, and allows the hydrogen gas whose pressure level has been adjusted to be supplied to the hydrogen pipeline 1. In each of the hydrogen consumption devices 3, the controller 30 detects the current when electric power is supplied to a demand site, and obtains an amount of electric power output by the fuel cell based on the obtained current using a known arithmetic expression. The controller 30 further converts the obtained amount of electric power into a hydrogen consumption amount based on a known conversion formula, and transmits the obtained hydrogen consumption amount to the PC 8 of the hydrogen leak detection device 10 via the communication I/F 34. The PC 8 obtains a sum of the hydrogen consumption amounts received from the respective hydrogen consumption devices 3A to 3E. Assuming that the amount of the hydrogen gas measured by the flow sensor 7 is a hydrogen supply amount, the PC 8 determines whether there is a possibility of a hydrogen gas leak by comparing the hydrogen supply amount with the sum of the hydrogen consumption amounts. If the PC 8 determines that there is a possibility of a leak, the PC 8 controls the pressure reducing valve 4 to adjust the pressure level of the hydrogen gas to be supplied to the hydrogen pipeline 1 to 0.9 MPa. The PC 8 then obtains again a sum of the hydrogen consumption amounts received from the respective hydrogen consumption devices 3A to 3E. In a case where a difference between the hydrogen supply amount and the sum of the hydrogen consumption amounts has increased in accordance with an increase in pressure level, the PC 8 determines that a hydrogen gas leak has occurred.

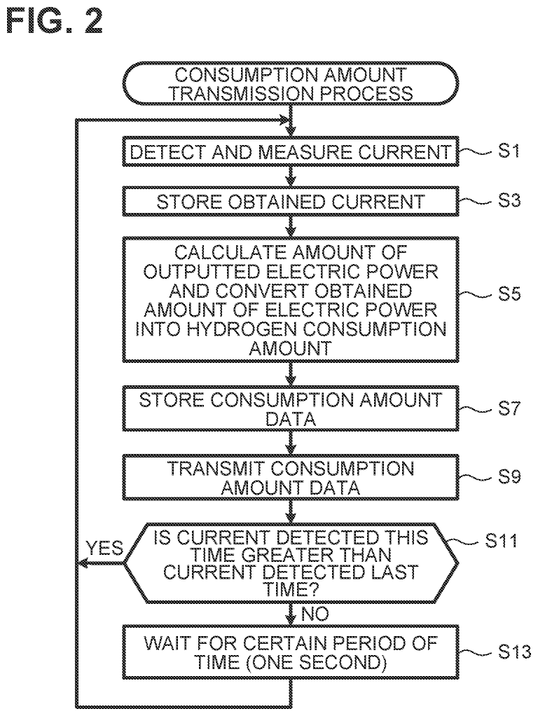

Next, referring to FIGS. 2 to 5, a description will be provided in details on a process in which the hydrogen leak detection device 10 detects the presence or absence of a hydrogen gas leak. First, referring to FIG. 2, a description will be provided on a consumption amount transmission process. The consumption amount transmission process is executed by the CPU 31 of the controller 30 of each of the hydrogen consumption devices 3 to provide the hydrogen leak detection device 10 with the hydrogen consumption amount. The consumption amount transmission process is executed by the CPU 31 of each of the hydrogen consumption devices 3A to 3E independently while the hydrogen consumption devices 3 are in operation. Each of the hydrogen consumption devices 3 generates, by the fuel cell, electric power in an amount corresponding to a demand, and consumes hydrogen in an amount corresponding to the generated electric power. The CPU 31 of the controller 30 detects and measures, with the current sensor 35, current passing through the current sensor 35 when electric power is supplied to a demand site (S1), and stores the obtained current in the SSD 37 (S3). Based on the obtained current, the CPU 31 calculates an amount of electric power output by the fuel cell using the known calculation formula. The CPU 31 further converts the obtained amount of electric power into a hydrogen consumption amount based on the known conversion formula (S5). The CPU 31 stores the converted hydrogen consumption amount in the SSD 37 as consumption amount data (S7).

The CPU 31 transmits the consumption amount data to the PC 8 of the hydrogen leak detection device 10 via the communication I/F 34 (S9). The CPU 31 compares the current detected last time with the current detected this time among the currents stored in the SSD 37 (S11). If the CPU 31 determines that the current detected this time is greater than the current detected last time (S11: YES), the routine returns to S1. The CPU 31 again detects and measures the current, obtains and transmits the hydrogen consumption amount to the hydrogen leak detection device 10. If the CPU 31 determines that the current detected this time is less than or equal to the current detected last time, the CPU 31 waits for a certain period of time, for example, one second (S13), and the routine returns to S1. The CPU 31 repeats a series of processing including detecting and measuring the current, obtaining the hydrogen consumption amount, and transmitting the obtained hydrogen consumption amount to the hydrogen leak detection device 10.

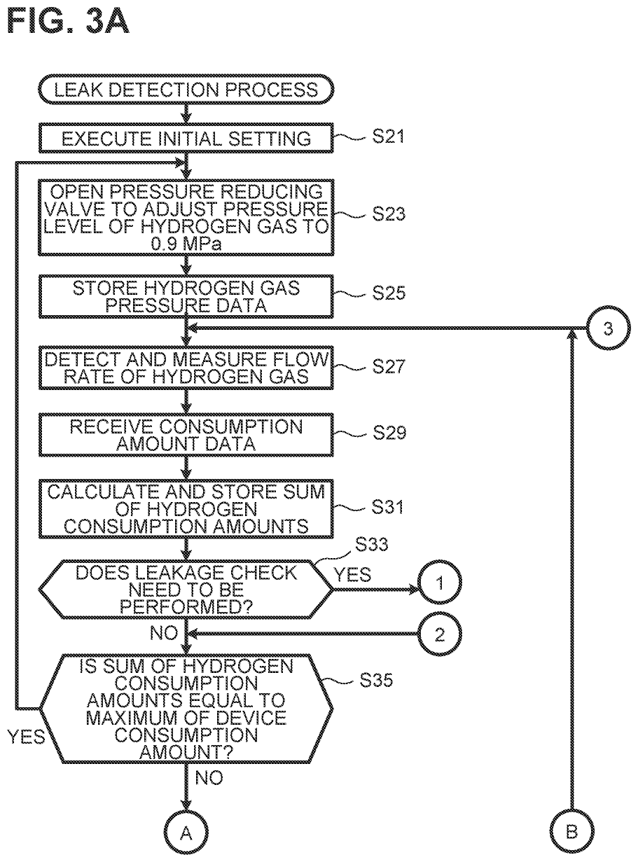

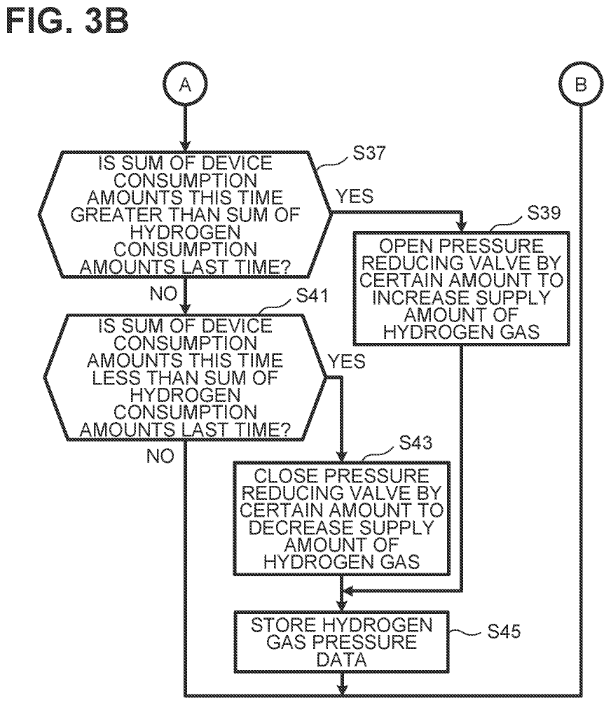

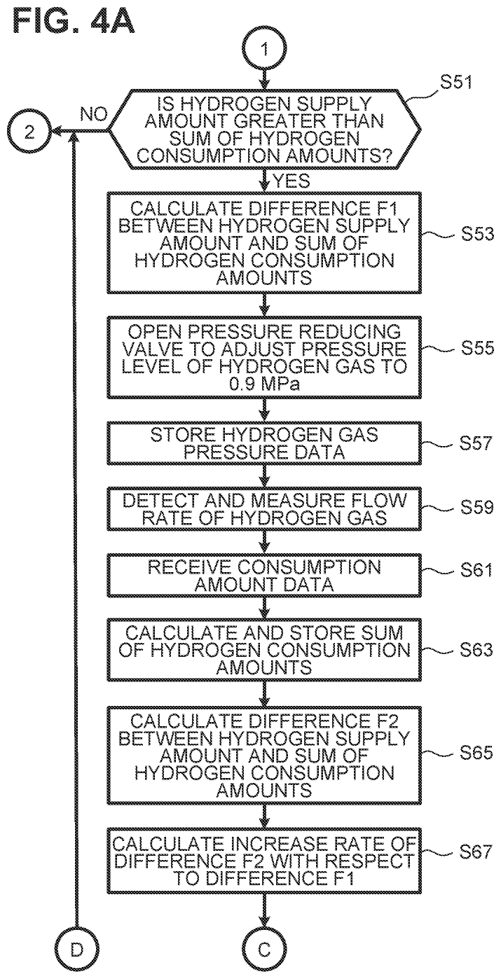

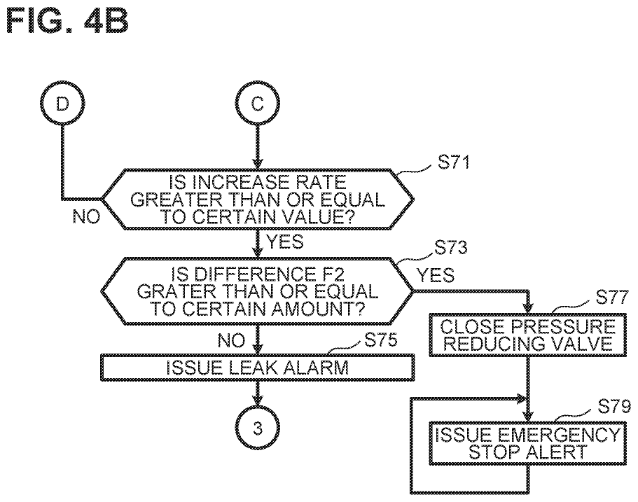

Next, referring to FIGS. 3 and 4, a description will be provided on a leak detection process executed by the CPU 81 of the PC 8 in the hydrogen leak detection device 10. The leak detection process is executed by the CPU 81 of the PC 8 while the hydrogen leak detection device 10 is in operation. In response to starting the leak detection process, the CPU 81 executes an initial setting (S21). In the initial setting, the CPU 81 executes, for example, processing of initializing flags and data stored in the RAM 83, and processing of connecting the CPU 81 to the motor 5 for opening and closing the pressure reducing valve 4, the pressure indicator 6, and the flow sensor 7. The CPU 81 controls the motor 5 to open the pressure reducing valve 4, and executes feedback processing based on the measurement result of the pressure indicator 6 to adjust the pressure level of the hydrogen gas to be supplied to the hydrogen pipeline 1 to 0.9 MPa (S23). After the pressure level adjustment, the CPU 81 detects and measures the pressure of the hydrogen gas with the pressure indicator 6 and stores the obtained pressure in the SSD 86 as hydrogen gas pressure data (S25).

The CPU 81 detects and measures, with the flow sensor 7, the amount of the hydrogen gas flowing in the hydrogen pipeline 1, and temporarily stores the obtained amount in the RAM 83 (S27). The CPU 81 receives the consumption amount data from each of the hydrogen consumption devices 3A to 3E via the communication I/F 87 (S29). The routine continues executing S29 until the CPU 81 receives the consumption amount data from all of the hydrogen consumption devices 3A to 3E. In response to completing receiving the consumption amount data from each of the hydrogen consumption devices 3A to 3E, the CPU 81 calculates a sum of the hydrogen consumption amounts of the hydrogen consumption devices 3A to 3E, and stores the sum as a history in the SSD 86 in association with time information received from a clock of the PC 8 (S31).

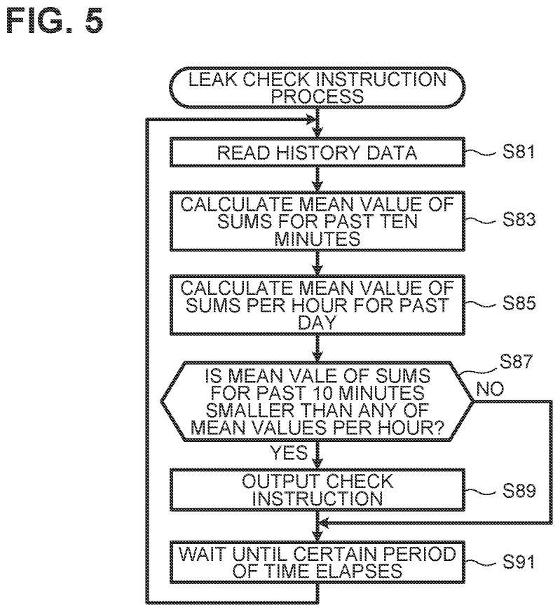

Next, the CPU 81 determines whether a leak check needs to be performed (S33). The leak check is performed in response to a check instruction. The check instruction is provided in a leak check instruction process (refer to FIG. 5). The check instruction according to the illustrative embodiment is indicated by a flag and stored in the RAM 83. If the CPU 81 determines that leak check does not need to be performed (S33: NO), the CPU 81 determines whether the sum of the hydrogen consumption amounts calculated in S31 is equal to a maximum of a device consumption amount (S35). The maximum of the device consumption amount refers to a sum of the amounts of hydrogen consumed when the hydrogen consumption devices 3A to 3E generate a maximum electric power. If the CPU 81 determines that the sum of the hydrogen consumption amounts is equal to the maximum of the device consumption amount (S35: YES), the routine returns to S23. In S23, the CPU 81 controls the pressure reducing valve 4 to adjust the pressure level of the hydrogen gas to be supplied to the hydrogen pipeline 1 to 0.9 MPa, thereby maintaining the supply amount of the hydrogen gas higher than or equal to the demand amount.

If the CPU 81 determines that the sum of the hydrogen consumption amounts is less than the maximum of the device consumption amount (S35: NO), the CPU 81 reads consumption amount data stored last time in the SSD 86 and compares the last-time consumption amount data with this-time consumption amount data (S37, S41). If the sum of the hydrogen consumption amounts this time is greater than the sum of the hydrogen consumption amounts last time (S37: YES), the CPU 81 controls the motor 5 to open the pressure reducing valve 4 by a certain amount to increase the amount of the hydrogen gas supplied to the hydrogen pipeline 1 (S39). The CPU 81 again detects and measures the pressure of the hydrogen gas with the pressure indicator 6 and stores the obtained pressure in the SSD 86 as hydrogen gas pressure data (S45). The routine then returns to S27. If the sum of the hydrogen consumption amounts this time is less than the sum of the hydrogen consumption amounts last time (S37: NO, S41: YES), the CPU 81 controls the motor 5 to close the pressure reducing valve 4 by a certain amount to decrease the amount of the hydrogen gas supplied to the hydrogen pipeline 1 (S43). The CPU 81 again detects and measures the pressure of the hydrogen gas with the pressure indicator 6 and stores the obtained pressure in the SSD 86 as the hydrogen gas pressure data (S45). The routine then returns to S27. If the sum of the hydrogen consumption amounts this time is equal to the sum of the hydrogen consumption amounts last time (S37: NO, S41: NO), the routine returns to S27 without the CPU 81 performing the control of the pressure reducing valve 4. In a case where the leak check is not performed, the CPU 81 repeats S27 to S45 to control the pressure reducing valve 4 so that the amount of the hydrogen gas present in the hydrogen pipeline 1 is equal to a minimum amount corresponding to the consumption amounts of the hydrogen consumption devices 3.

Referring to FIG. 5, a description will be provided on the leak check instruction process. The leak check instruction process is executed by the CPU 81 of the PC 8 in parallel with the leak detection process. In response to starting the leak check instruction process, the CPU 81 reads history data indicating a history of the sum of the hydrogen consumption amounts stored in the SSD 86 (S81). The CPU 81 calculates, based on the history data, a mean value of the sums of the hydrogen consumption amounts using the sums of the hydrogen consumption amounts received from the respective hydrogen consumption devices 3 for the past 10 minutes (S83). Then, the CPU 81 calculates, based on the history data, a mean value of the sums of the hydrogen consumption amounts per hour using the sums of the hydrogen consumption amounts received from the hydrogen consumption devices 3 for the past day (S85).

The CPU 81 compares the mean value of the sums for the past 10 minutes with each of the mean values of the sums per hour for the past day (S87). If the CPU 81 determines that the mean value of the sums for the past 10 minutes is smaller than any of the mean values, each of which is the mean value of the sums per hour for the past day (S87: YES), the CPU 81 outputs a check instruction, to be specific, sets a flag corresponding to the check instruction to “ON” (S89). The routine waits until a certain period of time (e.g., 30 minutes) elapses (S91). After the certain period of time elapses (S91), the routine returns to S81. If the CPU 81 determines that the mean value of the sums for the past 10 minutes is equal to or greater than any of the mean values, each of which is the mean value of the sums per hour for the past day (S87: NO), the CPU 81 does not output a check instruction and the routine waits until the certain period of time elapses (S91). After the certain period of time elapses (S91), the routine returns to S81. As described above, the CPU 81 outputs the check instruction at a timing when the sum of the hydrogen consumption amounts is relatively small in a day.

The description will return to the leak detection process of FIG. 3A. If the CPU 81 sets the flag corresponding to the check instruction for the leak check to “ON” (S33: YES) while the control of the pressure reducing valve 4 is appropriately performed in S27 to S45, the CPU 81 executes S51 to S79 of FIGS. 4A and 4B to execute a hydrogen gas leak check. If the CPU 81 determines that the hydrogen supply amount that indicates the amount of the hydrogen gas detected in S27 is less than or equal to the sum of the hydrogen consumption amounts calculated in S31 (S51: NO), the CPU 81 determines that a difference therebetween is within a range of errors and no hydrogen gas leak has occurred in the hydrogen pipeline 1. Thus, the routine proceeds to S35. If the CPU 81 determines that the hydrogen supply amount is greater than the sum of the hydrogen consumption amounts (S51: YES), the CPU 81 calculates a difference F1 between the hydrogen supply amount and the sum of the hydrogen consumption amounts (S53). The difference F1 corresponds to an amount of hydrogen gas leaking from the hydrogen pipeline 1 or is within a range of errors between the hydrogen supply amount and the sum of the hydrogen consumption amounts.

The CPU 81 controls the motor 5 to open the pressure reducing valve 4 to adjust the pressure level of the hydrogen gas to be supplied to the hydrogen pipeline 1 to 0.9 MPa (S55). After the pressure level adjustment, the CPU 81 detects and measures the pressure of the hydrogen gas with the pressure indicator 6 and stores the obtained pressure in the SSD 86 as the hydrogen gas pressure data (S57). The CPU 81 detects and measures, with the flow sensor 7, the amount of the hydrogen gas flowing in the hydrogen pipeline 1, and temporarily stores the obtained amount in the RAM 83 (S59). The CPU 81 receives the consumption amount data from each of the hydrogen consumption devices 3A to 3E via the communication I/F 87 (S61). In response to completing receiving the consumption amount data from each of the hydrogen consumption devices 3A to 3E, the CPU 81 calculates a sum of the hydrogen consumption amounts of the hydrogen consumption devices 3A to the 3E, and stores the sum in the SSD 86 (S63).

The CPU 81 calculates a difference F2 between the hydrogen supply amount and the sum of the hydrogen consumption amounts (S65). The difference F2 corresponds to an amount of hydrogen gas leaking from the hydrogen pipeline 1 or is within a range of errors between the sum of the hydrogen consumption amounts and the hydrogen supply amount when the pressure of the hydrogen gas to be supplied is at 0.9 MPa. Next, the CPU 81 calculates an increase rate A of the difference F2 between the hydrogen supply amount and the sum of the hydrogen consumption amounts calculated in S61 after raising the pressure of the hydrogen gas to 0.9 MPa with respect to the difference F1 between the hydrogen supply amount and the sum of the hydrogen consumption amounts calculated in S53 before raising the pressure of the hydrogen gas (S67). If the CPU 81 determines that the increase rate A is less than a certain value (S71: NO), the routine proceeds to S35. In other words, the increase rate A of the difference F2 with respect to the difference F1 in response to the rise in the hydrogen gas pressure is not obtained. The CPU 81 thus determines, in S71, that no hydrogen gas leak has occurred and the difference between the sum of the hydrogen gas consumption amounts and the hydrogen gas supply amount is within a range of errors. The certain value to be compared with the increase rate A is set with reference to a table provided in advance in accordance with a rise in the pressure of the hydrogen gas measured in S57 after pressure raising with respect to the pressure of the hydrogen gas measured in S45 before pressure raising.

If the CPU 81 determines that the increase rate A is equal to or greater than the certain value (S71: YES), the CPU 81 determines that a hydrogen gas leak has occurred since the difference F2 has increased by the increase rate A in response to the rising of the hydrogen gas pressure. The CPU 81 then determines whether the difference F2 is equal to or greater than a certain amount (S73). If the CPU 81 determines that the difference F2 is less than the certain amount (S73: NO), the CPU 81 issues a leak alarm (S75). For example, the CPU 81 causes the display 84A to display a notification for notifying an occurrence of a hydrogen gas leak, and causes the speaker 90 to sound for notification (S75). In this case, the CPU 81 determines that the hydrogen consumption devices 3 can continue to generate electric power although the hydrogen pipeline 1 has been slightly broken and a small amount of the hydrogen gas is leaking and diffusing into the atmosphere. Thus, the routine proceeds to S27 and the CPU 81 repeats S27 to S45, thereby continuing the supply of the hydrogen gas to the hydrogen pipeline 1.

If the CPU 81 determines that the difference F2 is equal to or greater than the certain amount (S73: YES), the CPU 81 determines that the hydrogen pipeline 1 is severely damaged or broken and a large amount of hydrogen gas is leaking. The CPU 81 thus controls the motor 5 to close the pressure reducing valve 4 (S77). Thus, the supply of the hydrogen gas to the hydrogen pipeline 1 is stopped. The CPU 81 issues an emergency stop alert to cause the display 84A to display a warning that a hydrogen gas leak may have occurred and cause the speaker 90 to sound for warning (S79). The CPU 81 repeats S79 and stops supplying the hydrogen gas until an administrator takes action against the leak.

As described above, the hydrogen gas has a specific gravity less than that of the air. Even if the hydrogen gas leaks, the hydrogen gas diffuses into the air at once from the aerial hydrogen pipeline 1, thereby not staying at the hydrogen pipeline 1 and its surroundings. The hydrogen leak detection device 10 may detect a hydrogen gas leak in the hydrogen pipeline 1 readily by comparing the amount of hydrogen gas flowing in the gas tank 2 that is a supplier of the hydrogen gas and the sum of hydrogen consumption amounts of the hydrogen consumption devices 3 that are destinations of the hydrogen gas.

While the hydrogen gas is being supplied from the gas tank 2 to the hydrogen consumption devices 3, the hydrogen leak detection device 10 may determine whether a hydrogen gas leak has occurred in response to a check instruction output by the CPU 81 based on the result of the determination in S87 of the leak check instruction processing.

In a case where the amount of the hydrogen gas flowing in the hydrogen pipeline 1 is lower than the sum when the CPU 81 determines that a hydrogen leak has occurred in S51, reliability of the leak determination may be low due to measurement errors in the hydrogen consumption amounts of the hydrogen consumption devices 3 and the flow amount of the hydrogen gas measured by the flow sensor 7. Thus, in S55, the CPU 81 raises the pressure of the hydrogen gas to the certain level. Since the hydrogen gas has high fluidity, the flow amount of the hydrogen gas increases instantly in response to the pressure raising. If the current flow amount has increased as compared with the last flow amount in response to the pressure raising, the CPU 81 may reliably determine that a hydrogen leak has occurred. Since the flow amount of the hydrogen gas instantly changes correspondingly, the CPU 81 may readily determine whether a leak has occurred.

The CPU 81 controls the motor 5 to control the pressure reducing valve 4 so that the flow amount of the hydrogen gas being supplied to the hydrogen pipeline 1 changes following the hydrogen consumption amounts of the hydrogen consumption devices 3. That is, the CPU 81 controls the pressure reducing valve 4 so that a minimum amount of hydrogen gas is present in the hydrogen pipeline 1. In a case where the pressure of the hydrogen gas is raised in S55 of the leak check, a difference between the flow amount before the pressure raising and the flow amount after the pressure raising may be widen. Thus, the CPU 81 may more reliably determine whether a hydrogen leak has occurred. The pressure of the hydrogen gas is not maintained at a high pressure at all times. Thus, a pressure load on the hydrogen pipeline 1 may be relieved. In addition, the CPU 81 adjusts the amount of hydrogen gas present in the hydrogen pipeline 1 to the minimum amount under normal conditions. Such adjustment may limit an amount of hydrogen gas leaking even if a hydrogen gas leak occurs, thereby enhancing safety.

The CPU 81 may continue supplying the hydrogen gas normally after the pressure raising in S55 in order to determine whether a hydrogen gas leak has occurred.

If the CPU 81 determines that the amount of hydrogen gas leaking is equal to or greater than the certain value, the CPU 81 immediately stops supplying the hydrogen gas in S77, thereby securing safety.

Performing the hydrogen gas leak check while each of the hydrogen consumption devices 3 consumes a small amount of hydrogen gas enables the CPU 81 to detect the presence or absence of a leak with higher reliability. Thus, the CPU 81 may appropriately set and change the timing of the leak check in accordance with the timing when each of the hydrogen consumption devices 3 consumes a relatively small amount of hydrogen.

The amount of hydrogen consumption in the hydrogen pipeline 1 varies in season or hours of a day according to a usage situation of a consumer. The sum of the hydrogen consumption with respect to each check instruction is managed as the history in association with a check timing and a time when the check was performed. The CPU 81 may thus appropriately change the timing of issuing the check instruction.

In the illustrative embodiment, the pressure reducing valve 4 and the motor 5 correspond to a “pressure regulator”. The PC 8 corresponds to a “controller”. The communication I/F 34 and the communication I/F 87 correspond to a “communication device”. The branching part 11 corresponds to a “branching position”. The flow sensor 7 corresponds to a “flow sensor”.

The difference F1 corresponds to a “first difference”. The difference F2 corresponds to a “second difference”.

The disclosure may be variously modified from the above-described illustrative embodiment. Various modification examples described below may be combined with each other as long as no contradiction arises. In the illustrative embodiment, the PC 8 may be, for example, a personal computer. Nevertheless, a dedicated controller using an ASIC may be used to control the on/off valve of the pressure reducing valve 4. The communication I/F 34 of each of the hydrogen consumption devices 3 may be a communication device that is provided separately from a corresponding one of the hydrogen consumption devices 3 and performs wired or wireless data communication with the PC 8. The controller 30 of each of the hydrogen consumption devices 3 may be equipped with a flash memory, an HDD, or other memory instead of the SSD 37. The pressure reducing valve 4 and the pressure indicator 6 are provided independently of each other and connected to the pipeline segment 1F. Nevertheless, the pressure reducing valve 4 and the pressure indicator 6 may be integral with each other, for example, the pressure reducing valve 4 may be provided with the pressure indicator 6. The PC 8 of the hydrogen leak detection device 10 may be equipped with a flash memory, an HDD, or other memory instead of the SSD 86. The communication I/F 87 of the PC 8 may be, for example, a communication device that is connected to the PC 8 via the USB I/F 88 and performs wired or wireless data transmission with each of the hydrogen consumption devices 3.

The CPU 81 of the PC 8 executes the leak check instruction process and sets a flag ON as the check instruction that is issued in a case where the leak check needs to be performed. Nevertheless, another controller device different from the PC 8 may execute the leak check instruction process and output the check instruction to the PC 8. In another example, an administrator may be allowed to set a desired timing of the leak check, and the check instruction may be output, to the PC 8, by a device that outputs the check instruction when the timing of the leak check comes based on measurement of a timer or using a program that can be executed by the PC 8. In S71, the CPU 81 compares the increase rate A with the certain value. Nevertheless, if the difference F2 is greater than the difference F1, the CPU 81 may determine that a hydrogen gas leak has occurred, and the routine may proceed to the S73. In the leak check instruction process, in one example, the check instruction is output if the mean value of the sum of the hydrogen consumption amounts for the past 10 minutes is smaller than the mean value of the sum of the hydrogen consumption amounts for each hour in the past day. Nevertheless, in another example, the check instruction may be output in a time period, a timing or a season in which the mean value of the sum of the hydrogen consumption amounts is smaller than the mean value of the sum of the hydrogen consumption amounts for the past 6 hours, for the past 12 hours, for the past one month, or for the past one year. The emergency stop alert is issued by the display 84A of the PC 8 to display the warning and by the speaker 90 of the PC 8 to sound the warning sound. Nevertheless, another way may be used that enables the administrator to notice the issuance of the emergency stop alert more reliably, such as lighting of a rotating light, sounding of an alarm, or transmission of an emergency mail addressing to the administrator from the PC 8.

While the disclosure has been described in detail with reference to the specific embodiment thereof, this is merely an example, and various changes, arrangements and modifications may be applied therein without departing from the spirit and scope of the disclosure.

What is claimed is:

1. A hydrogen leakage detection device for detecting a hydrogen gas leak at an aerial hydrogen pipeline for supplying hydrogen gas from a gas tank to a plurality of hydrogen consumption devices, the hydrogen pipeline including a hydrogen channel that extends from the gas tank and branches off at branching positions to the plurality of hydrogen consumption devices, the hydrogen leakage detection device, comprising:
a pressure regulator disposed at the hydrogen pipeline and adjacent to the gas tank, the pressure regulator being configured to adjust a pressure of the hydrogen gas discharged from the gas tank;
a controller configured to control the pressure regulator;
a communication device connected to the controller and each of the plurality of hydrogen consumption devices, the communication device enables the controller and the plurality of hydrogen consumption devices to communicate with each other; and
a flow sensor disposed upstream from a particular branching position at the hydrogen channel, the particular branching position being closest to the gas tank among the branching positions, the flow sensor being configured to measure a flow amount of the hydrogen gas flowing in the hydrogen pipeline and transmits the measured flow amount to the controller,
wherein the controller is configured to:
receive a first hydrogen consumption amount from each of the hydrogen consumption devices via the communication device;
control the pressure regulator such that a first flow amount of the hydrogen gas flowing in the hydrogen pipeline corresponds to an amount equal to a first sum of the first hydrogen consumption amounts;
in response to a check instruction outputted based on establishment of a particular condition or at a particular timing, receive a second hydrogen consumption amount from each of the hydrogen consumption devices and a second flow amount measured by the flow sensor;
determine whether the second flow amount is greater than a second sum of the second hydrogen consumption amounts; and
in response to a determination that the second flow amount is greater than the second sum of the second hydrogen consumption amounts, determine that a hydrogen gas leak has occurred.

2. The hydrogen leakage detection device according to claim 1, further comprising a check instruction issuing device,
wherein the particular timing is changeable, and
wherein the check instruction issuing device configured to issue the check instruction at the particular timing.

3. The hydrogen leakage detection device according to claim 1, wherein the controller is further configured to:
calculate a first difference between the second flow amount of the hydrogen gas and the second sum of the second hydrogen consumption amounts;
in response to the determination that a hydrogen gas leak has occurred, stop controlling the pressure regulator such that the first flow amount of the hydrogen gas flowing in the hydrogen pipeline corresponds to the amount equal to the first sum of the first hydrogen consumption amounts, and control the pressure regulator to raise the pressure of the hydrogen gas to a particular pressure corresponding to a maximum pressure allowable in the hydrogen pipeline;
subsequent to raising the pressure of the hydrogen gas to the particular pressure, receive a third hydrogen consumption amount from each of the hydrogen consumption devices and a third flow amount measured by the flow sensor;
calculate a second difference between the third flow amount and the third sum of the third hydrogen consumption amounts;
determine whether the second difference is greater than the first difference; and
in response to a determination that the second difference is greater than the first difference, determine that the hydrogen gas leak has occurred.

4. The hydrogen leakage detection device according to claim 3, wherein the controller is further configured to:
in response to the determination that the hydrogen gas leak has occurred based on the determination as to whether the second difference is greater than the first difference, provide a notification that the hydrogen gas leak has occurred; and
in response to completion of the determination as to whether the second difference is greater than the first difference, cancel the stop of the control of the pressure regulator.

5. The hydrogen leakage detection device according to claim 4, wherein the controller is further configured to:
in response to the determination that the hydrogen gas leak has occurred based on the determination as to whether the second difference is greater than the first difference, determine whether the second difference is greater than a particular value; and
in response to a determination that the second difference is greater than the particular value, stop the supply of the hydrogen gas from the gas tank.

6. The hydrogen leakage detection device according to claim 2, wherein the check instruction issuing device is further configured to change the particular timing.

7. The hydrogen leakage detection device according to claim 6,
wherein the controller includes the check instruction issuing device,
wherein the controller includes a storage unit configured to store, as a history, a control timing at which the control of the pressure regulator is performed and a sum of a hydrogen consumption amount received from each of the plurality of hydrogen consumption devices in association with each other, and
wherein the controller is further configured to, based on the history stored in the storage unit, change the particular timing to a timing at which the sum of the hydrogen consumption amounts is relatively low in a particular repeat period.

8. A controller of a hydrogen leak detection device for detecting a hydrogen gas leak at an aerial hydrogen pipeline for supplying hydrogen gas from a gas tank to a plurality of hydrogen consumption devices,
wherein the hydrogen pipeline includes a hydrogen channel that extends from the gas tank and branches off at branching positions to the plurality of hydrogen consumption devices,
wherein the hydrogen leak detection device includes:
a pressure regulator disposed at the hydrogen pipeline and adjacent to the gas tank, the pressure regulator being configured to adjust a pressure of the hydrogen gas discharged from the gas tank;
a communication device connected to each of the plurality of hydrogen consumption devices, the communication device enabling the controller to communicate with each of the plurality of hydrogen consumption devices; and
a flow sensor disposed upstream from a particular branching position at the hydrogen channel, the particular branching position being closest to the gas tank among the branching positions, the flow sensor being configured to measure a flow amount of the hydrogen gas flowing in the hydrogen pipeline and transmits the measured flow amount to the controller,
wherein the controller is configured to control the pressure regulator and the communication device, the controller being configured to:
receive a first hydrogen consumption amount from each of the hydrogen consumption devices via the communication device;
control the pressure regulator such that a first flow amount of the hydrogen gas flowing in the hydrogen pipeline corresponds to an amount equal to a first sum of the first hydrogen consumption amounts;
in response to a check instruction outputted based on establishment of a particular condition or at a particular timing, receive a second hydrogen consumption amount from each of the hydrogen consumption devices and a second flow amount measured by the flow sensor;
determine whether the second flow amount is greater than a second sum of the second hydrogen consumption amounts; and
in response to a determination that the second flow amount is greater than the second sum of the second hydrogen consumption amounts, determine that a hydrogen gas leak has occurred.

9. A method of detecting a hydrogen leak at a hydrogen pipeline connecting a gas tank and a plurality of hydrogen consumption devices, the hydrogen pipeline including a pressure regulator configured to adjust a pressure of hydrogen gas discharged from the gas tank and a flow sensor configured to measure a flow amount of the hydrogen gas flowing in the hydrogen pipeline, the pressure regulator and the flow sensor being disposed adjacent to the gas tank, the method comprising:
controlling the pressure regulator during hydrogen gas supply such that a first flow amount of the hydrogen gas flowing in the hydrogen pipeline corresponds to an amount equal to a first sum of first hydrogen consumption amounts;
in response to a check instruction outputted based on establishment of a particular condition, comparing the first flow amount measured by the flow sensor and the first sum,
based on a result of the comparison, determining whether the first flow amount is greater than the first sum,
in response to a determination that the first flow amount is greater than the first sum, determining that a hydrogen gas leak has occurred at the hydrogen pipeline,
in response to a determination that a hydrogen gas leak has occurred at the hydrogen pipeline, stopping controlling the pressure regulator such that the first flow amount of the hydrogen gas flowing in the hydrogen pipeline corresponds to the amount equal to the first sum of the first hydrogen consumption amounts, and controlling the pressure regulator to raise the pressure of the hydrogen gas to a particular pressure;
subsequent to raising the pressure of the hydrogen gas to the particular pressure, receiving a second hydrogen consumption amount from each of the hydrogen consumption devices and a second flow amount measured by the flow sensor;
calculating a difference between the second flow amount and a second sum of the second hydrogen consumption amounts;
determining whether the difference is greater than the first difference; and
in response to a determination that the second difference is greater than the first difference, determining that the hydrogen gas leak has occurred.
